(19) United States
(12) Patent Application Publication
(10) Pub. No.: US 2007/0268589 A1
(43) Pub. Date: Nov. 22, 2007

(54) A 3D IMAGE MULTIPLEXING SCHEME COMPENSATING FOR LENS ALIGNMENT ERRORS AND VIEWING LOCATION CHANGE IN 3D MONITOR

(75) Inventors: Jong-Beom Ra, Daejeon (KR); Yun-Gu Lee, Daejeon (KR)

Correspondence Address: GREENBLUM & BERNSTEIN, P.L.C., 1950 ROLAND CLARKE PLACE, RESTON, VA, 20191, US

(73) Assignee: KOREA ADVANCED INSTITUTE OF SCIENCE AND TECHNOLOGY, Daejeon (KR)

(21) Appl. No.: 11/462,095

(22) Filed: Aug. 3, 2006

(30) Foreign Application Priority Data
May 19, 2006 (KR) 10-2006-0044956

(51) Int. Cl. G02B 27/10

(52) U.S. Cl. 359/619

(57) ABSTRACT

The present invention relates to a method for multiplexing an optimal 3D image, by detecting inhomogeneity and alignment error of lens in a lenticular 3D LCD monitor, minimizing the image distortion caused by the detected error, and considering the viewer's position.

Thus, the method in accordance with the present invention is characterized by supplementing the mapping table for compensating the image distortion to the mapping table representing the relationship between N original view images and a multi-view image multiplexed to a 3D image. Thus, the present invention discloses a method for detecting the alignment error and inhomogeneity of lens by predicting the alignment error and inhomogeneity of lens in 3D monitor using intentionally generated test images, calculating the image index difference between the sub-pixel having to be originally observed from a viewer's eyes and the practically observed image pixel. Moreover, the present invention discloses a method for compensating the distance of a viewer by calculating the index difference between the sub-pixel having to be observed by the viewer located at optimal viewing position and the sub-pixel observed at the practical viewer's position, in the method for compensating the image distortion according to a viewer's position.

### TECHNICAL FIELD

The present invention relates to a method for reducing image distortion phenomenon caused by the inhomogeneous pitch characteristic of lens and the alignment error of lens in a lenticular 3D LCD monitor or a lenticular display. It additionally compensates the image distortion occurred according to a viewer's position.

Thus, the method in accordance with the present invention is characterized by supplementing the mapping table for compensating the image distortion to the mapping table representing the relationship between N original view images and a multi-view image multiplexed to a 3D image. Thus, the present invention discloses a method for detecting the alignment error and inhomogeneity of lens by predicting the alignment error and inhomogeneity of lens in 3D monitor using intentionally generated test images, calculating the image index difference between the sub-pixel having to be originally observed from a viewer's eyes and the practically observed sub-pixel. Moreover, the present invention discloses a method for compensating the distance of a viewer by calculating the index difference between the sub-pixel having to be observed by the viewer located at optimal viewing position and the sub-pixel observed at the practical viewer's position, in the method for compensating the image distortion according to a viewer's position.

### BACKGROUND ART

As shown in FIG. 1, the lenticular display reflects with lens the light of pixels located on LCD panel. Thereby, the phenomenon that other pixels are visible according to the viewer's eye position is occurred. Therefore, the images incoming to left eye and right eye become to be different, respectively. Since human recognizes an object in 3D through the disparity of the images incoming to left and right eyes, these display systems enable human to be aware of 3D images.

FIG. 2 is a cross sectional drawing in which FIG. 1 is cut in horizontal direction.

Since left eye observes the 8th viewing zone and right eye observes the 5th viewing zone, the viewer's two eyes become to see different pixel values. As shown in FIG. 2, since each eye is located at one of N different viewing zones, N different images can be observed according to the eye position. Such a system is called as a N-view lenticular display system.

A lenticular display system can be manufactured by attaching cylinder-shape lens on LCD panel(referring to FIG. 1). Since however the resolutions of the observed 3D image in horizontal and vertical directions become to be largely different, a slanted lenticular display system attaching cylinder-shape lens on LCD panel at a slant was developed.

The horizontal size of each sub-pixel for R, G, B on LCD panel is S very narrow(about less than 0.1 mm). Since however cylinder-shape lens should be attached and precisely aligned on LCD panel as shown in FIG. 3, precise accuracy is required. Thus, it is very difficult to attach a cylinder-shape lens on LCD panel and to avoid alignment error. Since however even a trivial alignment error causes the considerable image distortion, this alignment error becomes the problem to degrade the image quality of a lenticular display system.

### [Disclosure]

### [Technical Problem]

Since the alignment error of lens in 3D display using lens is not the intentional error, it can not be guaranteed to reduce the error even if the alignment error is measured/known and the lens is attached again precisely on LCD panel. That is, with hardware approaches, it is not easy to precisely align the lens individually for the respective display system. Moreover, since the pitch of lens is very narrow, the lens with entirely homogenous pitch is expensive and is not easy to be manufactured. However, the image distortion becomes to be occurred when inhomogeneous lens is used. Hereinafter, the alignment error of lens and inhomogeneous lens are called as extrinsic problems.

The 3D display using lens displays 3D image in only restricted zones. If a viewer escapes from these zones, the distortion phenomenon becomes to be occurred in the observed image. These observable zones are determined when the lens to be attached on the display system is designed, and these are fixed values which can not be changed after being determined. Hereinafter, the problems according to a viewer's position are called as intrinsic problems.

Therefore, the present invention is a software approach based on signal processing, and the objective of the present invention is to provide an algorithm for compensating the image distortion caused by the above problems.

### [Technical Solution]

As the subject matters for achieving the above objective, the present invention provides;

1) a method for compensating the image distortion in order to resolve the above problems, characterized by supplementing the mapping table for compensating the image distortion caused by the above problems to the mapping table representing the relationship between N original view images and a multi-view image multiplexed to 3D image.

2) a method for recognizing the alignment error of lens and inhomogeneous characteristic of lens in a 3D monitor, characterized by detecting the alignment error and inhomogeneity of lens by predicting the alignment error and inhomogeneity of lens in a 3D monitor using intentionally generated test images, calculating the difference between the image index of sub-pixel having to be ideally observed from a viewer's eye and the image index of a practically observed sub-pixel.

3) a method for compensating the image distortion according to the viewer's position, characterized by compensating the distance of a viewer by calculating the index difference between the sub-pixel having to be observed by the viewer located at optimal viewing position and the sub-pixel observed at the practical viewer's position.

4) a method for compensating the image distortion according to the viewer's position, characterized in that a plurality of view images are displayed inside the image observed at each viewing zone in the case that the alignment error or inhomogeneity of lens exists when the alignment error or inhomogeneity of lens in said 3D monitor is predicted.

### [Advantageous Effects]

As described in the above, the image compensation method according to the image distortion caused by the alignment error of inhomogeneous lens in a lenticular 3D monitor and a viewer's position in accordance with the present invention has the following advantageous effects.

1) With recognizing the precise alignment error and inhomogeneity, the alignment error which is difficult to be physically compensated because of a minute error can be reduced by using the proposed invention, thereby the image distortion phenomenon can be reduced.

2) It is possible to make the system considering the viewer's position escape from the limitation of the lenticular system which provides optimal 3D image in only restricted space.

### DESCRIPTION OF DRAWINGS

FIG. 1 is a drawing of a lenticular display system in accordance with prior arts.

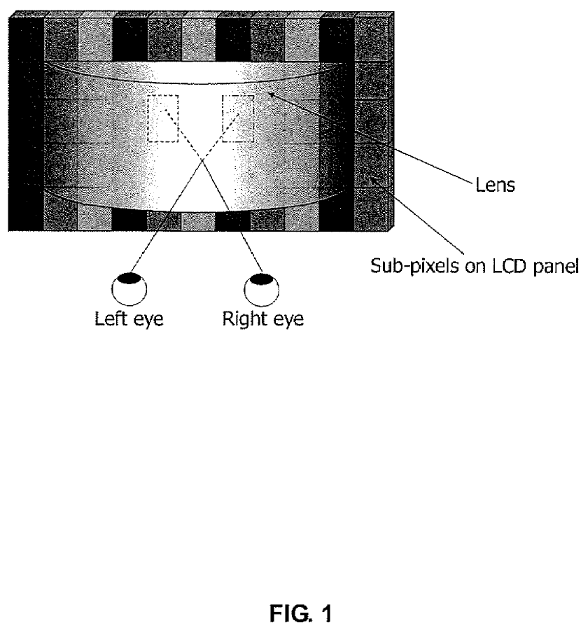

FIG. 2 is a cross sectional drawing showing the operational principles of a lenticular display system in accordance with prior arts.

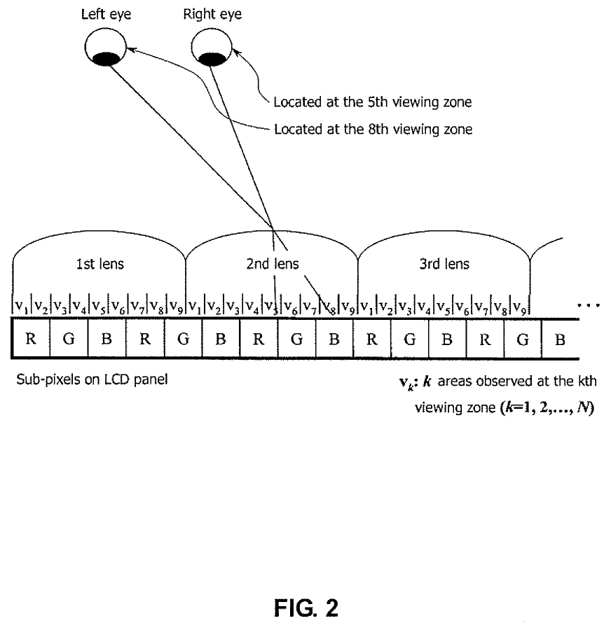

FIG. 3 is a drawing of a slanted lens-type lenticular display system in accordance with prior arts.

FIG. 4 is a cross sectional drawing illustrating the changes of the location observed according to a viewer's position and the compensation according to the above changes in accordance with the present invention.

FIG. 5 is a cross sectional drawing illustrating the changes due to the inhomogeneity and alignment error of lens and the compensation according to the above changes in accordance with the present invention.

### MODE FOR INVENTION

Hereinafter, referring to appended drawings, the structures and operational principles for the embodiments of present invention are described in detail.

If we assume that T_{O} denotes the original mapping table, the final mapping table T_{F} that resolves all the above mentioned intrinsic and extrinsic problems can be represented as

T_{F}=T_{O}+T_{E}+T_{I} [Equation 1]

Here, T_{E} denotes the term compensating the problem occurred due to the alignment error and inhomogeneity of lens, and T_{I} denotes the term which a viewer's position is considered.

And T_{F}, T_{O}, T_{E}, T_{I} are matrices with the size of M×N, where M and N are vertical and horizontal resolutions of LCD panel. While the values in T_{E} are constants for the given display system, the values in Tᵢ are variables which vary according to a viewer's eye position. Here, all the values in the table have floating point accuracy.

T_{O} is calculated by [Equation 2] in an N-view 3D display system.

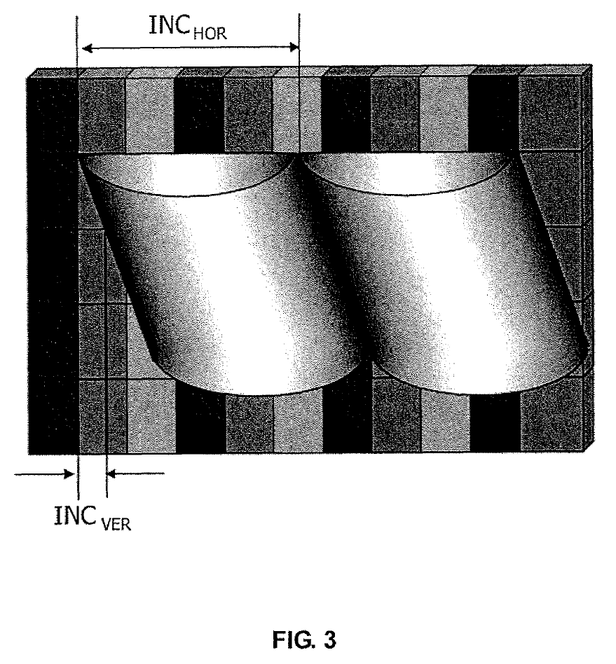

T₀(m,n)=(INC_{VER}×n+(N/INC_{HOR})×m)%N [Equation 2]

where, (m, n) denotes the position of a sub-pixel, (A % B) means the remainder when A is divided by B. INC_{VER} and INC_{HOR} are constant values representing the relationship between lens and LCD panel. INC_{HOR} denotes the value of pitch for lens to a horizontal direction, and INC_{VER} denotes the value of moving amount for lens to a horizontal direction between successive lens, as defined in FIG. 3. While the values of INC_{VER} and INC_{HOR} can be varied by alignment error, it is not necessary to consider the alignment error in the process of obtaining T_{O} since the alignment error occurred at this time is compensated in other processes.

The method for predicting T_{I} is explained in detail as follows.

In order to compensate mismatch between the view index of original mapping table and the view index of sub-pixels which are practically observed at a viewing zone where a viewer's eye locates, T_{I} is introduced.

In order to predict T_{I}, the displacement, d, between the practically observed position and the position observed at the optimal viewing distance is calculated.

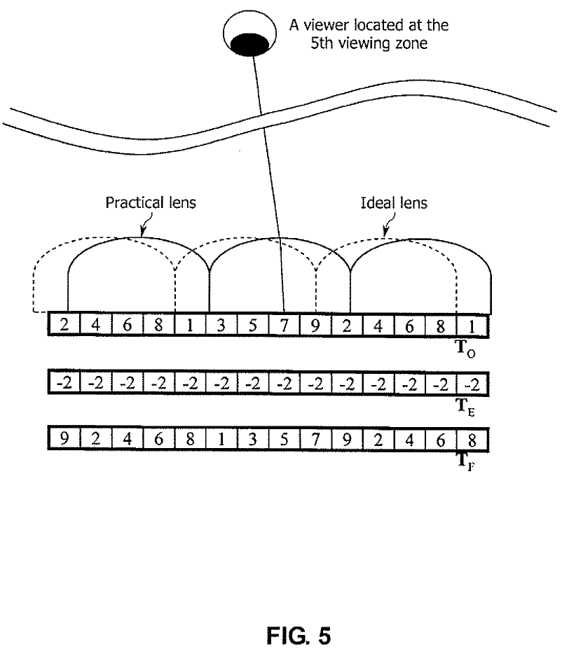

For example, let's assume the viewer A₅ is located at the 5th viewing zone, as shown in FIG. 5. In this case, the 7th sub-pixel should be observed when A₅ observes the 2nd lens.

However, since A₅ is not located at the optimal position, the viewer, A₅, becomes to observe the 6th sub-pixel, and thus the error of the displacement d is occurred. The value of d can be calculated as

$$d = f \frac{{L}_{H}}{\sqrt{{n}_{r}^{2} ( {L}_{D}^{2} + {L}_{H}^{2} ) - {L}_{H}^{2}}} \qquad [ Equation 2 ]$$

Here, f is the focal length of the lens, L_{D} denotes the vertical distance between the eye and the lens. L_{H} denotes the horizontal distance from the center of the observing lens to the 5th viewing zone. nᵣ is the reflective index of the lens.

The value of d is interpreted as a shift or change of view index in the mapping table.

For example, the position observed from the eye A₅ is shifted by 1 sub-pixel to the left at the 2nd lens. For the purpose of resolving this problem, this value is considered when the mapping table is compensated. Since the difference of view index between successive sub-pixels is 2 for 9-view system, a shift of 1 sub-pixel corresponds to a shift of two viewing zones.

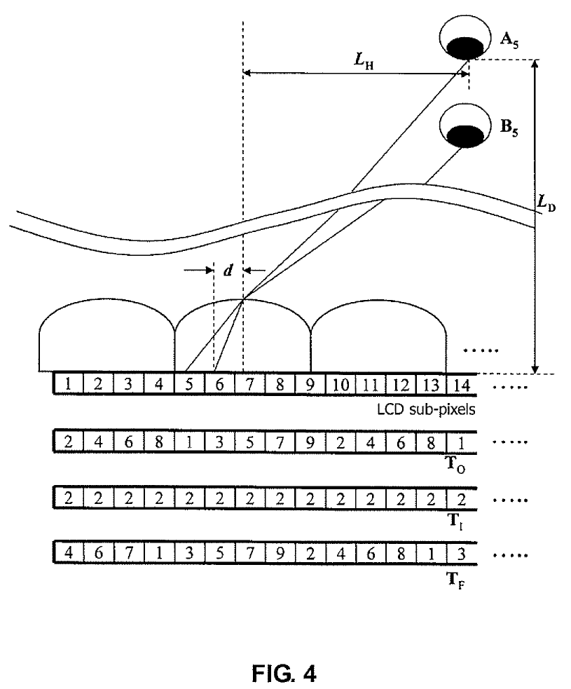

Hence, the value of T_{I} at the corresponding sub-pixel is set to 2, as shown in FIG. 4. In general, the value of d for each sub-pixel located at (m, n) in T_{I} is represented as d(m, n), and it is defined as

$${T}_{1} ( m , n ) ≡ - \frac{2 d ( m , n )}{{p}_{L}} \\ ( mod 9 ) \qquad [ Equation 3 ]$$

where, (m, n) denotes the position of sub-pixel on LCD panel and P_{L} is the horizontal length of a sub-pixel. Note that all the values of T_{I} can be obtained by only calculating the values for a single row.

The method for predicting T_{E} is explained in detail as follows.

The inhomogeneity and misalignment of lens cause the mismatch problem between LCD pixel and lens. In order to resolve the mismatch problem between LCD pixel and lens, T_{E} is suggested.

FIG. 5 shows the relationship among T_{O}, T_{E}, and T_{F}.

In an example of FIG. 5, a viewer located at the 5th viewing zone sees a sub-pixel that is sampled from the 7th view image. Thus, the value of T_{E} for the corresponding sub-pixel should be compensated to −2.

That is, if the precise geometric relationship between LCD pixel and lens is known, the value of T_{E} can be predicted. While we just consider 9 view lenticular display system in the followings, it can be extended to N view lenticular display.

In order to predict the misalignment and inhomogeneity of lens, 9 3D pattern images are used. The ith view image is set to white and the others are set to black, and then they are multiplexed by using original mapping table, and thereby the ith 3D pattern image is generated. Each 3D pattern image is observed at the 5th viewing zone.

Here, in order to avoid the image distortion caused by the intrinsic problem, the images should be obtained at the distance sufficiently far from the display system.

If there is no extrinsic problem, the only 5th pattern image becomes a white image and the others become black ones. In this case, all the values of T_{E} are set to 0. Otherwise, the values of T_{E} are calculated from the captured pattern images.

If the point (n, m) in the ith captured pattern image is white, the viewer located at the 5th viewing zone becomes to observe the sub-pixel sampled at (n, m) in the ith view image. Thus, the value of T_{E} at (n, m) should be set to (5-i) as shown in FIG. 3.

If there is only an alignment error without inhomogeneity in lens, a simpler compensation method can be applied. In the case of homogenous lens, the pitch of lens is constant irrelevant to the position of lens. Thus, the value of T_{E} calculated by using observed pattern image is increased to horizontal direction with a constant value. Let's assume the increment amount of the value between successive sub-pixels is α. The real value of INC_{HOR} value (i.e., INC_{HOR,REAL}) representing the practical status of lens mounted on LCD panel can be obtained by using α. The value can be calculated by [Equation 5].

INC_{HOR,REAL}=N/(N/INC_{HOR}+α) [Equation 5]

Likewise, in the case of homogenous lens, the value of T_{E} is increased to vertical direction with a constant value, Let's assume the value is β. In this case, the real INC_{VER,REAL} can be predicted by [Equation 6].

INC_{VER,REAL}=INC_{VER}+β [Equation 6]

Therefore, in the case that there is only an alignment error in homogeneous lens, T_{F} can be obtained not by calculating T_{E} as shown in [Equation 1] but by applying precise values of INC_{HOR,REAL} and INC_{VER,REAL} to [Equation 1] as shown in the following [Equation 7].

T_{F}=T_{O,E}+T_{I} [Equation 7]

Where, the mapping table, T_{O,E}(m,n), representing the relation among multi-view images multiplexed in 3D with N original view images after compensating the error and detecting alignment error of lens in a 3D lenticular monitor can be obtained by [Equation 8].

T_{O,E}(m,n)=(INC_{VER,REAL}×n+(N/INC_{HOR,REAL})×m)%N [Equation 8]

Since those having ordinary knowledge and skill in the art of the present invention will recognize additional modifications and applications within the scope thereof, the scope of present invention should not be limited to the embodiments and drawings described above, but should be determined by the Claims.

### INDUSTRIAL APPLICABILITY

The present invention relates to a method for reducing image distortion phenomenon occurred by the inhomogeneous pitch characteristics and the alignment error of lens in a lenticular 3D LCD monitor or a lenticular display. It additionally compensates the image distortion occurred according to a viewer's position. The method in accordance with the present invention has the following advantageous effects.

1) With recognizing precise alignment error and inhomogeneity, the alignment error which is difficult to be physically compensated because of a minute error can be reduced by using the proposed invention, thereby the image distortion phenomenon can be reduced.

2) It is possible to make the system considering viewer's position escape from the limitation of the lenticular system which provides optimal 3D image in only restricted space.

1. A method for detecting the misalignment of inhomogeneous lens and compensating the image distortion by considering a viewer's position in a 3D monitor, characterized by comprising
the step for making the mapping table representing the relationship between N original view images and a multi-view image multiplexed to 3D image,
the step for making the mapping table detecting the alignment error or the inhomogeneity of lens in a 3D monitor, and
the step for making the mapping table compensating the image distortion according to a viewer's position.

2. The method of claim 1,
characterized by
representing the mapping table of said step 3 with [Equation 9].
$${T}_{1} ( m , n ) = - \frac{2 d ( m , n )}{n} \% N \qquad [ Equation 9 ]$$
(where, (m, n) denotes the position of a sub-pixel on LCD panel and P_{L} is the horizontal length of a sub-pixel. Note that all the values of T_{I} can be obtained by only calculating the values for a single row.)

3. The method of claim 1,
in said step for making the mapping table detecting the alignment error or the inhomogeneity of lens in a 3D monitor,
characterized by
predicting the alignment error or inhomogeneity of lens in a 3D monitor by using test images, and
detecting the alignment error or inhomogeneity of lens by calculating the difference between the image index of the sub-pixel having to be originally observed from a viewer's eye and the image index of the is practically observed sub-pixel.

4. The method of claim 1,
characterized in said step 2 by
predicting said alignment error or inhomogeneity of lens in a 3D lenticular monitor by using test images, and
detecting said alignment error or inhomogeneity of lens by using the relationship of spatial positions between lens and LCD pixel(or sub-pixel) in a 3D lenticular monitor.

5. A method for detecting the alignment error of homogeneous lens and compensating the image distortion by considering a viewer's position in a 3D lenticular monitor, characterized by comprising
the step 1 for compensating the error after detecting alignment error of the lens in a 3D lenticular monitor,
the step 2 for making the mapping table representing the relationship between N original view images and a multi-view image multiplexed to 3D image,
the step 3 for making the mapping table compensating the image distortion according to a viewer's position.

6. The method of claim 5,
characterized in that a plurality of view images are displayed inside the image observed at each viewing zone in the case that the alignment error or inhomogeneity of lens exists when the alignment error or inhomogeneity of lens in said 3D lenticular monitor is predicted.

7. The method of claim 1,
characterized in said step 3 by
compensating the distance of a viewer by calculating the index difference between the sub-pixel having to be observed by the viewer located at optimal viewing position and the sub-pixel observed at the practical viewer's position.

8. The method of claim 5,
characterized in said step 3 by
compensating the distance of a viewer by calculating the index difference between the sub-pixel having to be observed by the viewer located at optimal viewing position and the sub-pixel observed at the practical viewer's position.

9. The method of claim 7,
characterized by using [Equation 10]for compensating said distance of a viewer,
$$d = f \frac{{L}_{H}}{\sqrt{{n}_{r}^{2} ( {L}_{D}^{2} + {L}_{H}^{2} ) - {L}_{H}^{2}}} \qquad [ Equation 10 ]$$
(Here, f is the focal length of the lens, L_{D} denotes the vertical distance between the eye and the lens. L_{H} denotes the horizontal distance from the center of the observing lens to the 5th viewing zone. nᵣ is the reflective index of the lens.)

10. The method of claim 5,
characterized in that said mapping table of said step 2 is represented by [Equation 12].
T_{O,E}(m,n)=(INC_{VER,REAL}×n+(N/INC_{HOR,REAL})×m)%N [Equation 12]
(Where, (m, n) denotes the position of a sub-pixel, (A % B) means the remainder when A is divided by B. INC_{HOR,REAL} is the real value of INC_{HOR} denoting the value of pitch for lens to a horizontal direction, INC_{VER,REAL} is the real value of INC_{VER} denoting the value of moving amount of lens to a horizontal direction between successive lens.)

11. A 3D image multiplexing method for applying [Equation 13] for inhomogeneous lens and [Equation 14] for homogeneous lens in a 3D lenticular monitor,
T_{F}=T_{O}+T_{E}+T_{I} [Equation 13]
T_{F}=T_{O,E}+T_{I}. [Equation 14]
(Where, T_{O} denotes the original mapping table, T_{F} denotes the final mapping table, T_{E} denotes the term compensating the problem occurred due to the alignment error and inhomogeneity of lens, T_{I} denotes the term in which a viewer's position is considered, and T_{O.E} denotes the mapping table for compensating the alignment error.)

12. A 3D image multiplexing apparatus for applying [Equation 15] for inhomogeneous lens and [Equation 16] for homogeneous lens in a 3D lenticular monitor,
T_{F}=T_{O}+T_{E}+T_{I} [Equation 15]
T_{F}=T_{O,E}+T_{I}. [Equation 16]
(Where, T_{O} denotes the original mapping table, T_{F} denotes the final mapping table, T_{E} denotes the term compensating the problem occurred due to the alignment error and inhomogeneity of lens, T_{I} denotes the term in which a viewer's position is considered, and T_{O,E} denotes the mapping table for compensating the alignment error.)

13. The 3D image multiplexing apparatus of claim 12,
characterized in that said T_{I} is represented by [Equation 17].
$${T}_{1} ( m , n ) = - \frac{2 d ( m , n )}{n} \% N \qquad [ Equation 17 ]$$
(Where, (m, n) denotes the position of sub-pixel on LCD panel and PL is the horizontal length of a sub-pixel. Note that all the values of T_{I} can be obtained by only calculating the values for a single row.)

14. The 3D image multiplexing apparatus of claim 12,
characterized in said T_{E},
by predicting the alignment error or inhomogeneity of lens in a 3D lenticular monitor by using test images, and
detecting alignment error or inhomogeneity of lens in a 3D lenticular monitor by calculating the difference between the image index of a sub-pixel having to be originally observed from a viewer's eye and the image index of a practically observed sub-pixel.

15. The 3D image multiplexing apparatus of claim 12,
characterized in said T_{E},
by obtaining the relationship of the spatial position between lens and LCD pixel(or sub-pixel) in a 3D lenticular monitor by using test images, and
compensating image distortion in a 3D lenticular monitor by using said relationship.

16. The 3D image multiplexing apparatus of claim 12,
characterized in that a plurality of view images are displayed inside the image observed at each viewing zone in the case that alignment error or inhomogeneity of lens is occurred when alignment error or inhomogeneity of lens is predicted in said 3D lenticular monitor.

17. The 3D image multiplexing apparatus of claim 12,
characterized in said T_{I},
by compensating the distance from a viewer by calculating the indices of the sub-pixel which has to be observed by the viewer located at a optimal position and the sub-pixel observed by the viewer located at a practical position.

18. The 3D image multiplexing apparatus of claim 17,
characterized by using [Equation 18] for compensating said distance from a viewer.
$$d = f \frac{{L}_{H}}{\sqrt{{n}_{r}^{2} ( {L}_{D}^{2} + {L}_{H}^{2} ) - {L}_{H}^{2}}} \qquad [ Equation 18 ]$$
(Where, f is the focal length of the lens, L_{D} denotes the vertical distance between the eye and the lens. L_{H} denotes the horizontal distance from the center of the observing lens to the 5th viewing zone. nᵣ is the reflective index of the lens.)

19. The 3D image multiplexing apparatus of claim 12,
characterized by representing T_{O} as [Equation 19] for said homogeneous lens,
T_{O,E}(m,n)=(INC_{VER,REAL}×n+(N/INC_{HOR,REAL})×m)%N [Equation 19]
(Where, (m, n) denotes the position of a sub-pixel, (A % B) means the remainder when A is divided by B. INC_{HOR,REAL} is the real value of INC_{HOR} denoting the value of pitch for lens to a horizontal direction, INC_{VER,REAL} is the real value of INC_{VER} denoting the value of moving amount of lens to a horizontal direction between successive lens.)
